(19) United States
(12) Patent Application Publication
(10) Pub. No.: US 2026/0175405 A1
(43) Pub. Date: Jun. 25, 2026

(54) ROBOTIC ARM, POWDER SCOOPING APPARATUS, AND EXPERIMENTAL DEVICE

(71) Applicant: SHENZHEN JINGTAI TECHNOLOGY CO., LTD., Shenzhen (CN)

(72) Inventors: Yang LIU, Shenzhen (CN); Wei WANG, Shenzhen (CN)

(21) Appl. No.: 19/430,961

(22) Filed: Dec. 23, 2025

Related U.S. Application Data
(63) Continuation of application No. PCT/CN2025/103622, filed on Jun. 25, 2025.

(30) Foreign Application Priority Data
Dec. 19, 2024 (CN) 202411900228.6

(51) Int. Cl. B25J 9/00; B25J 9/10; B25J 15/00

(52) U.S. Cl. CPC B25J 9/0048; B25J 9/104; B25J 15/0019

(57) ABSTRACT

A robotic arm, a powder scooping apparatus, and an experimental device are provided. The robotic arm includes a first support mechanism and a second support mechanism. The first support mechanism and the second support mechanism are both configured to be connected to an operating mechanism. At least one of the first support mechanism or the second support mechanism is configured to drive the operating mechanism to move. The at least one of the first support mechanism or the second support mechanism includes a support structure and a joint. The joint is rotatably connected to one end of the support structure. The joint is configured to be connected to the operating mechanism.

### CROSS-REFERENCE TO RELATED APPLICATIONS

This application is a continuation of International Application No. PCT/CN2025/103622, filed Jun. 25, 2025, which claims priority to Chinese Patent Application No. 202411900228.6, filed Dec. 19, 2024, the entire disclosure of which are incorporated herein by reference.

### TECHNICAL FIELD

This disclosure relates to the field of automated equipment technology, and in particular, to a robotic arm, a powder scooping apparatus, and an experiment device.

### BACKGROUND

In fields such as biology, pharmaceuticals, chemical engineering, and medical care, many experiments and production processes involve some delicate operations, such as solid powder quantitative addition, fixed-point pipetting, dispensing, etc. At present, these operations are performed manually or by using a general-purpose robotic arm.

### SUMMARY

In a first aspect, the present disclosure provides a robotic arm. The robotic arm includes a first support mechanism and a second support mechanism. The first support mechanism and the second support mechanism are both configured to be connected to an operating mechanism. At least one of the first support mechanism or the second support mechanism is configured to drive the operating mechanism to move. The at least one of the first support mechanism or the second support mechanism includes a support structure and a joint. The joint is rotatably connected to one end of the support structure. The joint is configured to be connected to the operating mechanism.

In a second aspect, the present disclosure further provides a powder scooping apparatus. The powder scooping apparatus includes an operating mechanism and the robotic arm in the first aspect. The operating mechanism is connected to each of the first support mechanism and the second support mechanism of the robotic arm, and is configured to scoop powder.

In a third aspect, the present disclosure further provides an experimental device. The experimental device includes the powder scooping apparatus in the second aspect.

### BRIEF DESCRIPTION OF THE DRAWINGS

To more clearly describe implementations in the present disclosure or technical solutions in related art, the accompanying drawings that need to be used in description of implementations or the related art will be briefly introduced below. Apparently, the accompanying drawings in the following description are only some implementations in the present disclosure, and those of ordinary skill in the art may also obtain other accompanying drawings based on these accompanying drawings without creative effort.

FIG. 1 is a front view of a powder scooping apparatus according to an embodiment.

FIG. 2 is a perspective view of a powder scooping apparatus according to an embodiment.

FIG. 3 is a perspective view of a powder scooping apparatus according to another embodiment.

FIG. 4 is a perspective view of a powder scooping apparatus according to yet another embodiment.

FIG. 5 is a partial cross-sectional view of the powder scooping apparatus in FIG. 4 taken along line L-L.

FIG. 6 is a perspective view of a powder scooping apparatus according to yet another embodiment.

FIG. 7 is a perspective view of a powder scooping apparatus according to yet another embodiment.

FIG. 8 is a schematic view of a powder scooping apparatus according to an embodiment.

FIG. 9 is a schematic view of an experimental device according to an embodiment.

FIG. 10 is a schematic view of an experimental device according to another embodiment.

Description of reference signs of the accompanying drawings: 10—first support mechanism, 20—second support mechanism, 30—operating mechanism, 31—first powder-scooping driving member, 32—sliding sleeve, 321—bushing, 322—guide shaft, 33—powder scooping rod, 331—scoop, 34—adapter, 35-connector, 361—second powder-scooping driving member, 362—first powder-scooping transmission member, 363—third powder-scooping driving member, 364—second powder-scooping transmission member, 371—screw shaft, 3711—helical groove, 3712—straight groove, 372—first nut, 373—second nut, 374-adapter sleeve, 375—bearing, 376—locking nut, 381—first synchronous pulley, 382—second synchronous pulley, 383—synchronous belt, 40—support structure, 41—first support member, 42—second support member, 43—connecting shaft, 44—first driving member, 45—first transmission member, 46—second driving member, 47—second transmission member, 48—third driving member, 481—stator, 482—mover, 483—guide member, 484—detecting member, 485—bottom plate, 486—end plate, 487—cover plate, 491—third transmission member, 4911—slider, 4912—connecting head, 4913—connecting arm, 492—fourth transmission member, 50—joint, 51—first rotating member, 511—first support portion, 512—connecting portion, 513—second support portion, 514—first rotating portion, 52—second rotating member, 521—second support frame; 522—second rotating portion, 61—first plate, 62—second plate, 63—third plate, 71—lead screw, 72—nut, 80—base, 81—first base, 82—second base, 90—moving mechanism, 100—robotic arm, 1000—powder scooping apparatus, 2000—experimental device.

### DETAILED DESCRIPTION

The following will illustrate clearly technical solutions of implementations of the present disclosure with reference to accompanying drawings of implementations of the present disclosure. The implementations illustrated herein are merely some, rather than all implementations, of the present disclosure. Based on the implementations of the present disclosure, other implementations obtained by those of ordinary skill in the art shall fall within the protection scope of the present disclosure.

It is to be noted that, when a component (element or member) is deemed as being “fixed” or “secured” to another component (element or member), the component (element or member) can be directly on the other component (element or member) or there may be an intermediate component (element or member) between the two components (elements or members). When a component (element or member) is considered to be “connected” or “coupled” to another component (element or member), the component (element or member) may be directly connected or coupled to the other component (element or member) or there may be an intermediate component (element or member) between the two components (elements or members).

Unless otherwise defined, all technical and scientific terms used herein have the same meaning as commonly understood by those skilled in the art of the present disclosure. The terms used herein in the present disclosure are for the purpose of describing specific embodiments only and are not intended to limit the present disclosure. The term “and/or” used herein includes any and all combinations of one or more related listed items. The term “at least one of A or B” used herein refers to A alone, B alone, or both A and B.

In fields such as biology, pharmaceuticals, chemical engineering, and medical care, many experiments and production processes involve some delicate operations, such as solid powder quantitative addition, fixed-point pipetting, dispensing, etc. At present, these operations are performed manually, which has disadvantages of high labor intensity and low operation accuracy; or these operations are performed by using a general-purpose robotic arm, however, the general-purpose robotic arm also has disadvantage of being incapable of free adjustment and having poor adaptability.

The purpose of the present disclosure is to provide a robotic arm, a powder scooping apparatus, and an experimental device, so as to solve the problem that a general-purpose robotic arm cannot be freely adjusted and has poor adaptability.

In order to achieve the purpose of the present disclosure, the present disclosure provides the following technical solutions.

Some implementations of the present disclosure will be described in detail below with reference to the accompanying drawings. The following embodiments and features in the embodiments can be combined with each other without conflict.

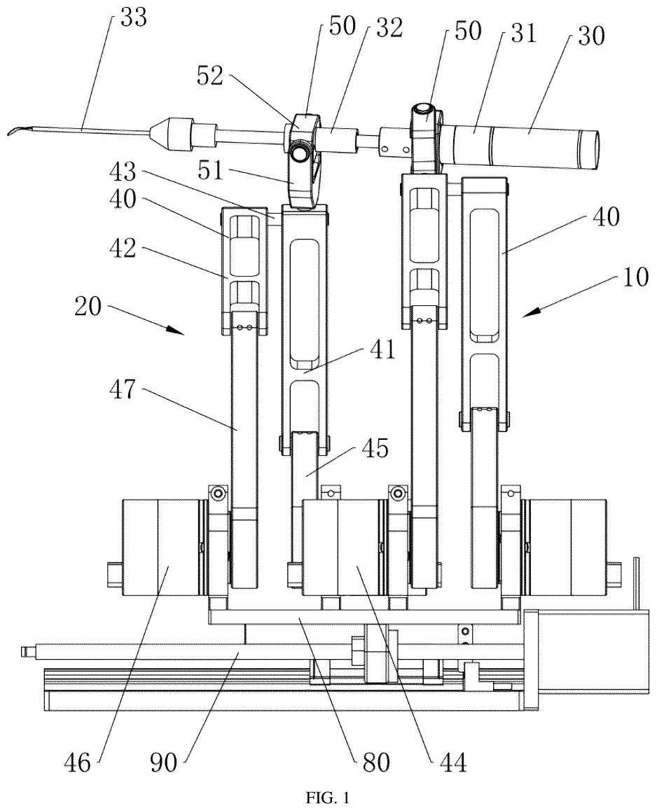

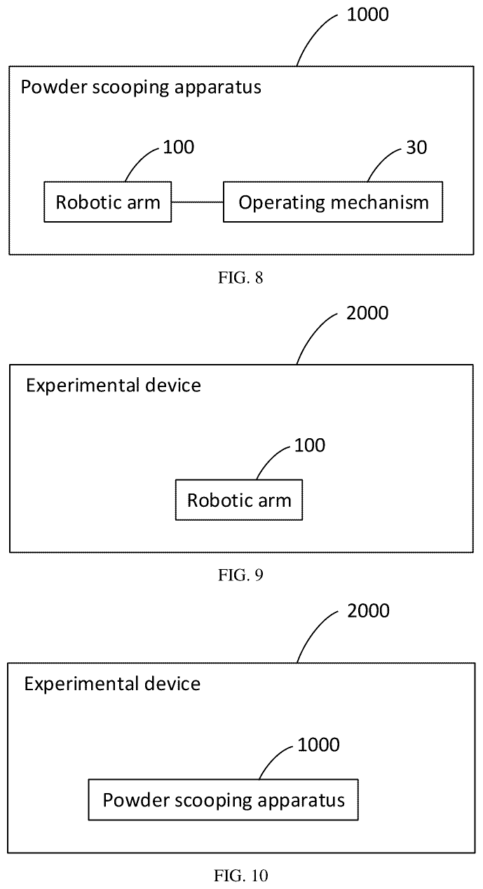

Referring to FIG. 1 to FIG. 8, a robotic arm 100 is provided in an embodiment of the present disclosure. The robotic arm 100 includes a first support mechanism 10 and a second support mechanism 20. The first support mechanism 10 and the second support mechanism 20 are both configured to be connected to an operating mechanism 30. At least one of the first support mechanism 10 or the second support mechanism 20 is configured to drive the operating mechanism 30 to move.

Specific structures of the first support mechanism 10 and the second support mechanism 20 are not limited. At least one of the first support mechanism 10 or the second support mechanism 20 is movable. Specifically, the first support mechanism 10 is fixed and the second support mechanism 20 is movable, or the first support mechanism 10 is movable and the second support mechanism 20 is fixed, or both the first support mechanism 10 and the second support mechanism 20 are movable. The motion may specifically be a translational motion, a rotational motion, or any other feasible motion manners, which is not limited herein.

The operating mechanism 30 may be of any feasible structure and is not limited. The operating mechanism 30 is configured to perform at least one required operation. For example, the operating mechanism 30 may be configured to perform operations such as dispensing, screwing, scooping, pipetting, and the like.

The first support mechanism 10 and the second support mechanism 20 are configured to be connected to different positions of the operating mechanism 30. One or both of the first support mechanism 10 and the second support mechanism 20 can move to drive the operating mechanism 30 to move, thereby driving the operating mechanism 30 to perform a required operation.

At least one of the first support mechanism 10 or the second support mechanism 20 includes a support structure 40 and a joint 50. The joint 50 is rotatably connected to one end of the support structure 40. The joint 50 is configured to be connected to the operating mechanism 30.

The specific structure of the support structure 40 and the joint 50 is not limited. The first support mechanism 10 may include the support structure 40 and the joint 50, and the second support mechanism 20 may be of other structures. Alternatively, the second support mechanism 20 may include the support structure 40 and the joint 50, and the first support mechanism 10 may be of other structures. Alternatively, each of the first support mechanism 10 and the second support mechanism 20 may include the support structure 40 and the joint 50.

The connection between the joint 50 and the operating mechanism 30 may be a fixed connection, a rotatable connection, or the like, which is not limited herein.

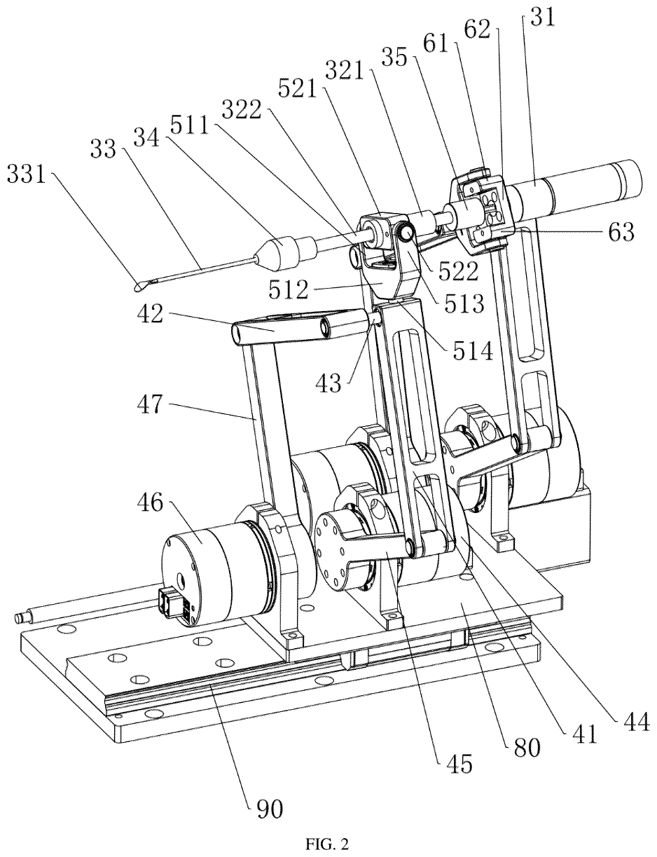

For example, referring to FIG. 1 and FIG. 2, each of the first support mechanism 10 and the second support mechanism 20 is movable, and each of the first support mechanism 10 and the second support mechanism 20 includes the support structure 40 and the joint 50. The joint 50 of the first support mechanism 10 and the joint 50 of the second support mechanism 20 are respectively connected to the operating mechanism 30 at two positions of the operating mechanism 30. At least one of the first support mechanism 10 or the second support mechanism 20 moves. During the motion, the joint 50 can rotate relative to the support structure 40, so as to drive the operating mechanism 30 to move, and the required operation is completed. Other embodiments will not be described in detail.

In the robotic arm 100 in the embodiment of the present disclosure, by providing the first support mechanism 10 and the second support mechanism 20, the operating mechanism 30 can be driven to move. In addition, the at least one of the first support mechanism 10 or the second support mechanism 20 includes the support structure 40 and the joint 50, and the joint 50 is rotatably connected to the support structure 40 and is connected to the operating mechanism 30. Therefore, the operating mechanism 30 can be moved to complete the required operation, without manual operation, thereby reducing labor intensity and improving operation accuracy. Compared with general-purpose robotic arm, the robotic arm 100 can be freely adjusted according to required operations and has strong adaptability.

According to the above description, the structure of the first support mechanism 10 and the structure of the second support mechanism 20 may be substantially the same or different, and hereinafter, one of the first support mechanism 10 and the second support mechanism 20 will be described in detail, and another of the first support mechanism 10 and the second support mechanism 20 can be referred to.

Optionally, referring to FIG. 1 and FIG. 2, for example, the second support mechanism 20 includes the support structure 40 and the joint 50. The joint 50 includes a first rotating member 51 and a second rotating member 52. The first rotating member 51 is rotatably connected to the support structure 40. The second rotating member 52 is rotatably connected to the first rotating member 51. The second rotating member 52 is configured to be connected to the operating mechanism 30. A rotation axis of the first rotating member 51 intersects with a rotation axis of the second rotating member 52.

Specific structures of the first rotating member 51 and the second rotating member 52 are not limited. The second rotating member 52 and the operating mechanism 30 may be fixedly connected or rotatably connected, which is not limited herein. The rotation axis of the first rotating member 51 and the rotation axis of the second rotating member 52 may be perpendicular or not perpendicular. For example, an angle between the rotation axis of the first rotating member 51 and the rotation axis of the second rotating member 52 is 30 degrees, 45 degrees, 55 degrees, 60 degrees, 90 degrees, or other values. Compared with the manner in which the rotation axis of the first rotating member 51 and the rotation axis of the second rotating member 52 are parallel, one more degree of freedom of rotation can be provided, which facilitates more free adjustment of the robotic arm 100 and increases the degree of freedom of motion of the operating mechanism 30. In addition, the rotation axis of the first rotating member 51 and the rotation axis of the second rotating member 52 may be coplanar or non-coplanar. When the rotation axis of the first rotating member 51 and the rotation axis of the second rotating member 52 are coplanar, the rotation stability of the structure can be improved.

Optionally, the first rotating member 51 includes a first support frame (not marked in the figure) and a first rotating portion 514. One end of the first rotating portion 514 is fixedly connected to the first support frame, and another end of the first rotating portion 514 is rotatably connected to the support structure 40. Optionally, the first rotating portion 514 may be rotatably connected to each of the first support frame and the support structure 40. The first rotating portion 514 may be a structure such as a rotating shaft or a universal joint.

Other optionally, the first rotating portion 514 is rotatably connected to the first support frame and fixedly connected to the support structure 40. In this embodiment, the first rotating portion 514 may be integrated with the support structure 40, that is, the first rotating member 51 may only include the first support frame.

Either way, the first support frame can be rotated relative to the support structure 40.

Optionally, the first support frame is U-shaped and includes a first support portion 511, a connecting portion 512, and a second support portion 513 which are connected in sequence. The first support portion 511 and the second support portion 513 face each other and are spaced apart from each other. Each of the first support portion 511, the connecting portion 512, and the second support portion 513 may be substantially plate-shaped, and may be of an integrated structure or a split structure, which is not limited herein.

Optionally, the first rotating portion 514 has a shape of rod linearly extending. One end of the first rotating portion 514 is connected to the connecting portion 512, and another end of the first rotating portion 514 protrudes from one side of the connecting portion 512 facing away from the first support portion 511. Optionally, the connecting portion 512 defines a hole, and the first rotating portion 514 passes through the hole and is connected to the connecting portion 512. As such, the first rotating member 51 is substantially in the shape of a slingshot frame as a whole.

Optionally, the first rotating member 51 is of an axisymmetric structure, and an axis of symmetry is a centerline of the first rotating portion 514. The symmetrical first rotating member 51 can help keep structural stability, reduce structural abrasion caused by asymmetric rotation, and avoid instability caused by structural imbalance.

Optionally, the second rotating member 52 includes a second support frame 521 and a second rotating portion 522. The second support frame 521 is disposed between the first support portion 511 and the second support portion 513. Each of two opposite ends of the second support frame 521 may be provided with the second rotating portion 522. One of the two second rotating portions 522 is connected to the first support portion 511, and another of the two second rotating portions 522 is connected to the second support portion 513. The second support frame 521 is rotatable relative to the first support frame. For example, the second rotating portion 522 may be rotatably connected to the first support frame and fixedly connected to the second support frame 521; or the second rotating portion 522 may be fixedly connected to the first support frame and rotatably connected to the second support frame 521; or the second rotating portion 522 may be rotatably connected to each of the first support frame and the second support frame 521, which is not limited herein. The second rotation portion 522 may be a rotating shaft.

Optionally, centerlines of the two second rotating portions 522 coincide with each other. The second rotating member 52 is of an axisymmetric structure, and an axis of symmetry is a centerline of each of the two second rotating portions 522. The symmetrical second rotating member 52 can help to keep structure stability, reduce structural abrasion caused by asymmetric rotation, and avoid instability caused by structure imbalance.

Optionally, the second support frame 521 defines a through-hole. The through-hole allows for mounting of the operating mechanism 30. The operating mechanism 30 can be connected and fixed to the second support frame 521, or can rotate and/or move relative to the second support frame 521. That is to say, the operating mechanism 30 may pass through the through-hole of the second support frame 521, which facilitates mounting of the operating mechanism 30 and is simple in structure.

The first rotating member 51 and the second rotating member 52 are rotatable with respect to the support structure 40, thereby providing two rotational degrees of freedom. When at least one of the first support mechanism 10 or the second support mechanism 20 drives the operating mechanism 30 to move, by rotation of the first rotating member 51 and/or the second rotating member 52, the operating mechanism 30 can be moved without jamming, so that the robotic arm 100 can drive the operating mechanism 30 to move to complete the required operation.

In the case that each of the first support mechanism 10 and the second support mechanism 20 has the joint 50, structures of the two joints 50 may be substantially the same or different, which is not limited herein.

Optionally, the second support frame 521 of the joint 50 of the first support mechanism 10 is roughly of a “U” shaped structure, and includes a first plate 61, a second plate 62, and a third plate 63 that are connected in sequence. The first plate 61 and the third plate 63 are spaced apart from and face each other. The first plate 61 is connected to one of the two second rotating portions 522, and the third plate 63 is connected to another of the two second rotating portions 522. The second plate 62 defines a through-hole. A surface of the second plate 62 facing away from the first plate 61 is used for being connected and fixed to a driving member of the operating mechanism 30. A rotating shaft of the driving member passes through the through-hole of the second plate 62. Structures such as an adapter and a connector 35 can be mounted in a space between the first plate 61 and the third plate 63, which is not limited herein.

Optionally, the second support frame 521 of the joint 50 of the second support mechanism 20 is substantially of a cubic structure, and two ends in a length direction thereof are separately connected to one second rotating portion 522.

Optionally, for example, the second support mechanism 20 includes the support structure 40 and the joint 50, and reference may be made to the first support mechanism 10. The support structure 40 includes a first support member 41 and a second support member 42. The joint 50 is rotatably connected to one end of the first support member 41. The second support member 42 is rotatably connected to the first support member 41. At least one of the first support member 41 or the second support member 42 is configured to move to drive the joint 50 to move.

Each of the first support member 41 and the second support member 42 extends substantially along a straight line or a curve, and has two opposite ends in the length direction. One end of the first support member 41 is connected to the first rotating member 51 (the first rotating portion 514) of the joint 50. Optionally, the first support member 41 extends along a straight line, and the straight line is parallel to the rotation axis of the first rotating member 51 (the centerline of the first rotating portion 514). In other words, the first rotating member 51 of the second support mechanism 20 rotates about an axis extending in the length direction of the first support member 41.

The first support member 41 and the second support member 42 may be connected through a connecting shaft 43, and at least one of the first support member 41 or the second support member 42 is rotatable relative to the connecting shaft 43, so that the first support member 41 and the second support member 42 may be rotatably connected. A centerline of the connecting shaft 43 intersects with each of the length direction of the first support member 41 and the length direction of the second support member 42, and may be further perpendicular to each of the length direction of the first support member 41 and the length direction of the second support member 42.

At least one of the first support member 41 or the second support member 42 performs an active motion. Since the first support member 41 and the second support member 42 are rotatably connected, so that the first support member 41 and the second support member 42 together support the joint 50 and drive the joint 50 to move. The active motion refers to that the at least one of the first support member 41 or the second support member 42 is moved under the action of the input power, while the motion is regarded as a follow-up motion in the absence of power input. For example, the first support member 41 performs the active motion, and the second support member 42 performs the follow-up motion; or the second support member 42 performs the active motion, and the first support member 41 performs the follow-up motion; or each of the first support member 41 and the second support member 42 performs the active motion. The active motion of the first support member 41 and/or the second support member 42 may be the translational motion, the rotational motion, or the like, which is not limited herein.

When the first support member 41 and/or the second support member 42 move, the position of the joint 50 can be changed, and the joint 50 is rotatably connected to one end of the first support member 41, so that the position of the operating mechanism 30 connected to the joint 50 can be changed, and the operating mechanism 30 can be moved flexibly without interference.

Optionally, referring to FIG. 1 and FIG. 2, the support structure 40 further includes a first driving member 44, a first transmission member 45, a second driving member 46, and a second transmission member 47. The first transmission member 45 is rotatably connected to the first support member 41. The second transmission member 47 is rotatably connected to the second support member 42. The first driving member 44 is connected to the first transmission member 45, and is configured to drive the first transmission member 45 to drive the first support member 41 to move. The second driving member 46 is connected to the second transmission member 47, and is configured to drive the second transmission member 47 to drive the second support member 42 to move.

Specific structures and types of the first driving member 44, the first transmission member 45, the second driving member 46 and the second transmission member 47 are not limited, and may be any feasible ones. For example, the first driving member 44 and the second driving member 46 may be a motor, an air cylinder, or the like. It should be understood that, according to the motion required by the operating mechanism 30, the first driving member 44 and/or the second driving member 46 can be controlled to work, and the first support member 41 and/or the second support member 42 are driven to move through the first transmission member 45 and/or the second transmission member 47, so as to adjust a position of the joint 50. That is, at least one of the first driving member 44 or the second driving member 46 may not operate. For example, the first driving member 44 does not operate and the second driving member 46 operates. Since the first driving member 44 does not operate, the first transmission member 45 does not operate either. However, since the first support member 41 is rotationally connected to the first transmission member 45, the first support member 41 can rotate relative to the first transmission member 45 when the second driving member 46 drives the second support member 42 to move through the second transmission member 47, so that the position of the joint 50 can also be changed. The embodiments of the present disclosure do not limit how the first driving member 44 and the second driving member 46 operate, as long as the joint 50 can be driven to move. The rotational connection manner between the first transmission member 45 and the first support member 41 and the rotational connection manner between the second transmission member 47 and the second support member 42 may be implemented by using a structure such as a rotating shaft or a universal joint, which is not limited herein.

Therefore, by providing the first driving member 44, the first transmission member 45, the second driving member 46, and the second transmission member 47, it is possible to flexibly adjust the position of the joint 50 by controlling whether and how the first driving member 44 and the second driving member 46 operate, and the adaptability is strong.

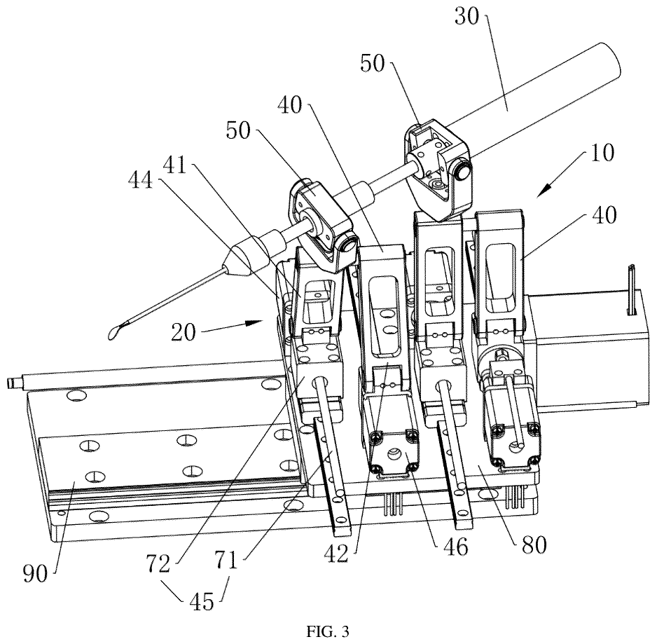

Optionally, referring to FIG. 1, FIG. 2, and FIG. 3, each of the first driving member 44 and the second driving member 46 is a rotary motor. Specifically, the rotary motor may be a servo motor, a stepping motor, or the like, and the rotary motor may be integrated with a speed reducer, a transmission, a brake, or other structures, which is not limited herein. Optionally, the first transmission member 45 includes any one or combination of a connecting rod, a lead screw and nut pair, a gear and rack pair, or a worm wheel and worm pair. Optionally, the second transmission member 47 includes any one or combination of a connecting rod, a lead screw and nut pair, a gear and rack pair, or a worm wheel and worm pair. The driving and transmission structures configured in this manner are all common structures, readily available, simple in structure, and low in cost.

Optionally, a rotation axis of the first driving member 44 is parallel to a rotation axis of the second driving member 46. In this way, a direction in which the first driving member 44 drives the first transmission member 45 to move (for example, to rotate or translate) is either the same as or opposite to a direction in which the second driving member 46 drives the second transmission member 47 to move (for example, to rotate or translate). Therefore, the structure and control logic can be simplified, and the excessively complex motion can be avoided to avoid a difficulty in controlling the motion of the joint 50.

In a specific embodiment, referring to FIG. 1 and FIG. 2, each of the first transmission member 45, the first support member 41, the second transmission member 47, and the second support member 42 is a connecting rod. The first transmission member 45 is rotatably connected to one end of the first support member 41 away from the joint 50. The second support member 42 is rotatably connected to one end of the first support member 41 close to the joint 50. The second transmission member 47 is rotatably connected to one end of the second support member 42 away from the joint 50.

Optionally, the axis of the first driving member 44 may coincide with the axis of the second driving member 46. Each of the first transmission member 45, the first support member 41, the second transmission member 47, and the second support member 42 is the connecting rod. The axis about which the first transmission member 45 and the first support member 41 rotate relative to each other, the axis about which the first support member 41 and the second support member 42 rotate relative to each other, and the axis about which the second transmission member 47 and the second support member 42 rotate relative to each other, are parallel to one another, and are all parallel to the axis of the first driving member 44. In this way, in the orthographic projection along the axis extension direction, the projection of the axis of the first driving member 44, the projection of the axis about which the first transmission member 45 and the first support member 41 rotate relative to each other, the projection of the axis about which the first support member 41 and the second support member 42 rotate relative to each other, and the projection of the axis about which the second transmission member 47 and the second support member 42 rotate relative to each other, are connected in sequence to form a quadrilateral structure. Any two adjacent edges of the quadrilateral structure can rotate relative to each other, so that the quadrilateral structure has good deformability, a simple structure, and a low cost. Preferably, in the orthographic projection along the axis extension direction, the projection of the axis of the first driving member 44, the projection of the axis about which the first transmission member 45 and the first support member 41 rotate relative to each other, the projection of the axis about which the first support member 41 and the second support member 42 rotate relative to each other, and the projection of the axis about which the second transmission member 47 and the second support member 42 rotate relative to each other, are connected in sequence to form the parallelogram structure. That is, the distance between the axis of the first driving member 44 and the axis about which the first transmission member 45 and the first support member 41 rotate relative to each other is equal to the distance between the axis about which the first support member 41 and the second support member 42 rotate relative to each other and the axis about which the second transmission member 47 and the second support member 42 rotate relative to each other, and the distance between the axis of the first driving member 44 and the axis about which the second transmission member 47 and the second support member 42 rotate relative to each other is equal to the distance between the axis about which the first transmission member 45 and the first support member 41 rotate relative to each other and the axis about which the first support member 41 and the second support member 42 rotate relative to each other. With this arrangement, the first transmission member 45, the first support member 41, the second transmission member 47, and the second support member 42 operate in coordination, so that both the stability and flexibility of the movement of the operating mechanism 30 can be improved.

Other optionally, the axis of the first driving member 44 may be parallel to and spaced apart from the axis of the second driving member 46.

Optionally, the axis about which the first transmission member 45 and the first support member 41 rotate relative to each other, the axis about which the first support member 41 and the second support member 42 rotate relative to each other, and the axis about which the second transmission member 47 and the second support member 42 rotate relative to each other, may be parallel to one another, but be non-parallel to the axis of the first driving member 44, such as be perpendicular to the axis of the first driving member 44, intersect the axis of the first driving member 44 at a non-perpendicular angle, etc.

Optionally, the axis about which the first transmission member 45 and the first support member 41 rotate relative to each other, the axis about which the first support member 41 and the second support member 42 rotate relative to each other, and the axis about which the second transmission member 47 and the second support member 42 rotate relative to each other, may also be non-parallel.

Referring to FIG. 6, in another specific embodiment, which is basically the same as the embodiment illustrated in FIG. 1 and FIG. 2, except that the first transmission member 45 is rotatably connected to the first support member 41 at a middle of the first support member 41, one end of the second support member 42 is connected to the second transmission member 47, and another end of the second support member 42 is rotatably connected to the end of the first support member 41 away from the joint 50.

The middle of the first support member 41 may be at the midpoint or near the midpoint (with a certain allowable distance from the midpoint). In this manner, the part of the first support member 41 between the middle of the first support member 41 and the joint 50 remains free from interference by the second support member 42, which facilitates more complex motion of the operating mechanism 30. In addition, the sizes of the second support member 42 and the second transmission member 47 can be appropriately reduced to reduce the space occupation of the structure.

In addition, the first support member 41 is equivalent to a lever with the first transmission member 45 as a fulcrum. Compared with a manner where the second support member 42 is rotatably connected to one end of the first support member 41 close to the joint 50, the second support member 42 moves in the opposite direction when the operating mechanism 30 performs the same motion. For example, when the operating mechanism 30 moves upwards, in the manner where the second support member 42 is rotatably connected to the end of the first support member 41 close to the joint 50, the second support member 42 moves towards the first support member 41. In contrast, when the operating mechanism 30 moves upwards, in the manner where the first transmission member 45 is rotatably connected to the first support member 41 at the middle of the first support member 41 and the second support member 42 is rotatably connected to the end of the first support member 41 away from the joint 50, the second support member 42 moves away from the first support member 41. Therefore, the operation manner of the first driving member 44 and the second driving member 46 can be adjusted more flexibly, which facilitates simplifying the control logic.

Optionally, referring to FIG. 1 and FIG. 2, the length of the first transmission member 45 is equal to the length of the second transmission member 47, and the length of the first support member 41 is equal to the length of the second support member 42. In this way, the structure is simple, the control logic is simple, the coordination is high, the implementation is easy, and the cost is low.

In another specific embodiment, referring to FIG. 3, the embodiment is basically the same as the embodiment illustrated in FIG. 1 and FIG. 2, except that each of the first transmission member 45 and the second transmission member 47 is a lead screw and nut pair. A lead screw 71 of the first transmission member 45 is connected to the first driving member 44. A lead screw 71 of the second transmission member 47 is connected to the second driving member 46. One end of the first support member 41 away from the joint 50 is rotatably connected to a nut 72 of the first transmission member 45. One end of the second support member 42 away from the joint 50 is rotatably connected to a nut 72 of the second transmission member 47.

In this embodiment, the connecting rod as the first transmission member 45 and the connecting rod as the second transmission member 47 in FIG. 1 and FIG. 2 are replaced with lead screw and nut pairs. In the embodiments in FIG. 1 and FIG. 2, the connecting rod as the first transmission member 45 and the connecting rod as the second transmission member 47 rotate. In contrast, in the embodiment illustrated in FIG. 3, each of the first driving member 44 and the second driving member 46 is a rotary motor, and an axis of the rotary motor is the same as an extending direction of a corresponding lead screw 71. The lead screw 71 is driven by the rotary motor to rotate, the nut 72 is driven by the lead screw 71 to move linearly, and the corresponding support member is driven by the nut 72 to move (or to translate and rotate), so that the joint 50 can be driven to move.

Optionally, referring to FIG. 3, the lead screw 71 of the first transmission member 45 and the lead screw 71 of the second transmission member 47 are arranged in parallel. Each of the first support member 41 and the second support member 42 is a connecting rod. The length of the first support member 41 is equal to the length of the second support member 42.

One end of the second support member 42 away from the nut 72 of the second transmission member 47 may be rotatably connected to one end of the first support member 41 close to the joint 50, or may be rotatably connected to the first support member 41 at a middle of the first support member 41, which is not limited herein. In this way, the structures of the first support member 41 and the second support member 42 are simple, and the size of the second support member 42 can be appropriately reduced. The lead screw 71 of the first transmission member 45 and the lead screw 71 of the second transmission member 47 are arranged in parallel, so that one end of the first support member 41 rotatably connected to the nut 72 of the first transmission member 45 and one end of the second support member 42 rotatably connected to the nut 72 of the second transmission member 47 can move relatively close to or relatively away from each other in the extending direction of the lead screw 71, which facilitates simplifying the control logic of the first driving member 44 and the second driving member 46, has a simple structure, small space occupation, and a low cost.

It can be understood that, the structure of the first support mechanism 10 may be substantially the same as the structure of the second support mechanism 20, for example, the support structure 40 of each of the first support mechanism 10 and the second support mechanism 20 is a combination of two rotary motors and four connecting rods illustrated in FIG. 1 and FIG. 2; or the support structure 40 of each of the first support mechanism 10 and the second support mechanism 20 is a combination of two rotary motors, two lead-screw-and-nut pairs, and two connecting rods illustrated in FIG. 3. The structure of the first support mechanism 10 may be different from the structure of the second support mechanism 20. For example, one of the support structure 40 of the first support mechanism 10 and the support structure 40 of the second support mechanism 20 is a combination of two rotary motors and four connecting rods, and another of the support structure 40 of the first support mechanism 10 and the support structure 40 of the second support mechanism 20 is a combination of two rotary motors, two lead-screw-and-nut pairs, and two connecting rods; or one of the support structure 40 of the first support mechanism 10 and the support structure 40 of the second support mechanism 20 is a combination of two rotary motors and four connecting rods, and another of the support structure 40 of the first support mechanism 10 and the support structure 40 of the second support mechanism 20 is a single supporting rod; or one of the support structure 40 of the first support mechanism 10 and the support structure 40 of the second support mechanism 20 is a combination of two rotary motors, two lead-screw-and-nut pairs, and two connecting rods, and another of the support structure 40 of the first support mechanism 10 and the support structure 40 of the second support mechanism 20 is a single supporting rod.

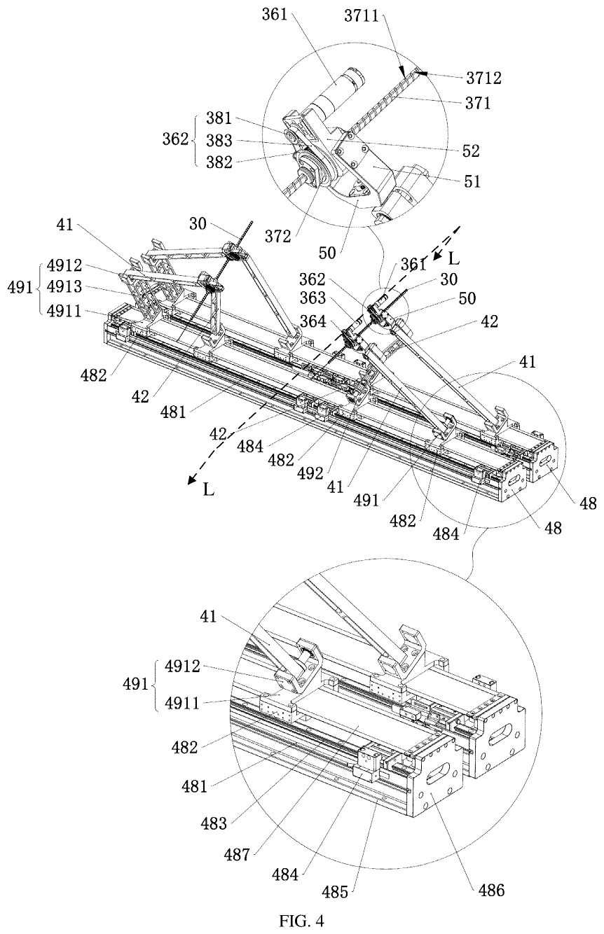

In another embodiment, referring to FIG. 4, the support structure 40 further includes a third driving member 48, a third transmission member 491, and a fourth transmission member 492. The third transmission member 491 is rotatably connected to the first support member 41. The fourth transmission member 492 is rotatably connected to the second support member 42. The third driving member 48 is connected to each of the third transmission member 491 and the fourth transmission member 492, and the third driving member 48 is configured to drive the third transmission member 491 and the fourth transmission member 492 to move independently.

One third driving member 48, one third transmission member 491, and one fourth transmission member 492 together form one group of power structures. In this embodiment, one or more groups of power structures may be provided. When one group of power structures is provided, one joint 50 can be driven to move. In combination with FIG. 1 to FIG. 3, the other joint 50 can be driven by any feasible structure in the foregoing embodiments, which is not limited herein. When multiple groups of power structures are provided, two of the multiple groups of power structures can drive two joints 50 connected to the same operating mechanism 30 to move, and the other groups of power structures can also drive the joints 50 connected to the other operating mechanisms 30 to move. For example, one third driving member 48 can independently drive more than two (e.g., four, six, eight, etc. ,) transmission members to move. By providing two third driving members 48 as illustrated in FIG. 4, multiple operating mechanisms 30 can be independently driven to operate, thereby improving apparatus flexibility and experimental throughput.

The third driving member 48, the third transmission member 491, and the fourth transmission member 492 may be any feasible structure. For example, the third driving member 48 may be a rotary motor, a linear motor, a hydraulic pump, an air cylinder, or the like, which is not limited herein. The third transmission member 491 and the fourth transmission member 492 may be a sliding block, a connecting rod, or various matching pairs. The third driving member 48 can drive the third transmission member 491 and the fourth transmission member 492 to move independently, so that the corresponding first support member 41 and the corresponding second support member 42 can be driven to move independently, and then the joint 50 connected to the first support member 41 and the second support member 42 can be driven to move. Thus, the posture or position of the operating mechanism 30 connected to the joint 50 can be adjusted.

By providing the third driving member 48 to drive the third transmission member 491 and the fourth transmission member 492 to move independently, compared with the structures illustrated in FIG. 1 to FIG. 3, one driving member can be removed, thereby reducing structural complexity and cost.

Optionally, referring to FIG. 4, the third driving member 48 is a linear motor. The linear motor includes multiple independently movable movers 482. The third transmission member 491 and the fourth transmission member 492 are connected to different movers 482 of the multiple movers 482.

Specifically, the linear motor as the third driving member 48 includes a stator 481 extending linearly and a guide member 483, and the guide member 483 is disposed on the stator 481 and extends in the same direction as the stator 481. The multiple movers 482 are slidably connected to the guide member 483. The stator 481 is configured to drive the multiple movers 482 to slide along the guide member 483 by means of an electromagnetic induction effect. The multiple movers 482 can move linearly along the guide member 483 independently of each other.

The guide member 483 may specifically be plate-shaped, rod-shaped, or the like. For example, the guide member 483 is a slide rail, a slide rod, or the like, which is not limited herein. The guide member 483 is an insulating member to avoid affecting the electromagnetic induction effect of the stator 481 and the mover 482. There may be multiple guide members 483 disposed on the stator 481 at intervals (for example, disposed at two opposite sides of the stator 481). The mover 482 may be directly mounted on the guide member 483. The mover 482 may also be mounted on the guide member 483 through a fit structure, which is not limited herein.

Optionally, the third driving member 48 is further provided with a detecting member 484. The detecting member 484 may be disposed on the guide member 483 and configured to detect a position of the mover 482. The detecting member 484 may be a grating detection structure, a photoelectric sensor, or the like. Exemplarily, the detecting member 484 consists of a grating ruler and two grating reading heads. The two grating reading heads are respectively connected to two movers 482, and move on the guide member 483 along with the movers 482. The grating ruler is disposed in an extending direction of the stator 481 and is located within a moving range of the two movers 482. By providing the detecting member 484, a moving position of the mover 482 can be precisely controlled, and collision with other structures can be avoided, thereby improving the operation accuracy and safety of the robotic arm 100.

A linear motor as one third driving member 48 may be provided with multiple movers 482. Two adjacent movers 482 are connected to the third transmission member 491 and the fourth transmission member 492 respectively; and the other two adjacent movers 482 may be connected to another third transmission member 491 and another fourth transmission member 492 respectively, or may be connected to other mechanisms. Thus, a more complex function can be implemented. Exemplarily, as illustrated in FIG. 4, one stator 481 is provided with four movers 482, two adjacent movers 482 form one group, and there are two groups of movers 482. Each group of movers 482 is respectively connected to a corresponding third transmission member 491 and a corresponding fourth transmission member 492, so as to drive the four corresponding transmission members to move.

The third driving member 48 may be multiple linear motors. Each linear motor may be provided with multiple independently movable movers 482. Exemplarily, when each of the first support mechanism 10 and the second support mechanism 20 includes the support structure 40 illustrated in FIG. 4, as illustrated in FIG. 4, the third driving member 48 is two linear motors, stators 481 of the two linear motors are parallel to each other, and each linear motor has four movers 482. There are two operating mechanisms 30, and each operating mechanism 30 is driven to operate by the motion of the four movers 482 on the two linear motors. The number of the mover 482 on each of the two linear motors can be more than four, which is not limited herein. By means of this arrangement, multiple identical or different operating mechanisms 30 can be driven at the same time to operate, thereby improving the experimental throughput, device flexibility and universality.

The third transmission member 491 and the fourth transmission member 492 may be connected and fixed to the corresponding movers 482, respectively. The first support member 41 and the second support member 42 may be rotatably connected to the corresponding transmission members, respectively.

By configuring the third driving member 48 as the linear motor with the multiple independently movable movers 482, the motion of the third transmission member 491 and the fourth transmission member 492 can be realized in a simple manner, and the structure is simple.

In an embodiment, referring to FIG. 4, each of the third transmission member 491 and the fourth transmission member 492 includes a slider 4911. The slider 4911 is connected to a corresponding mover 482 at one side of the slider 4911 facing towards the mover 482. The slider 4911 is rotatably connected to a corresponding support member at one side of the slider 4911 facing away from the mover 482. Each of the first support member 41 and the second support member 42 is a connecting rod.

The structure of the slider 4911 is not limited. The slider 4911 may be connected and fixed to the mover 482 by means of a connection method such as threaded connection, snap-fit connection, or the like. The slider 4911 can follow the motion of the mover 482 under the drive of the stator 481. The first support member 41 and the second support member 42 are configured as connecting rods, which is simple in structure and low in cost.

The manner in which the slider 4911 is rotatably connected to the corresponding support member, that is, the first support member 41 or the second support member 42, is not limited. Optionally, each of the third transmission member 491 and the fourth transmission member 492 further includes a connecting head 4912. The connecting head 4912 is fixedly connected to the slider 4911. The connecting head 4912 is rotatably connected to the corresponding support member. The specific structure of the connecting head 4912 is not limited, and may be configured as a structure that facilitates relative rotation with the corresponding support member. The connecting head 4912 may be connected to the slider 4911 by means of threaded connection, snap-fit connection, or any feasible manner, which is not limited herein. In this way, the slider 4911 can be rotatably connected to the corresponding support member through the connecting head 4912, so that the structure of the slider 4911 is simple, and the slider 4911 is easy to produce and manufacture.

Optionally, referring to FIG. 4, at least one of the third transmission member 491 or the fourth transmission member 492 further includes a connecting arm 4913. One end of the connecting arm 4913 is connected to a corresponding slider 4911, and another end of the connecting arm 4913 is rotatably connected to a corresponding support member.

One end of the connecting arm 4913 is fixedly connected to the slider 4911 by means of threaded connection, snap-fit connection, or any feasible connection manner. Another end of the connecting arm 4913 may be connected to a connecting head 4912, and is rotatably connected to the corresponding support member through the connecting head 4912.

The connecting arm 4913 may extend for a certain length along a straight line or a curved line, and may be rod-shaped or plate-shaped, which is not limited herein. Exemplarily, as illustrated in FIG. 4, a slider 4911 of one third transmission member 491 is fixedly connected to one end of one connecting arm 4913, another end of the connecting arm 4913 is fixedly connected to one connecting head 4912, and the connecting head 4912 is rotatably connected to the first support member 41.

By providing the connecting arm 4913, the spatial motion range of the corresponding support member can be enlarged, so that more complex adjustment of the motion posture and position of the operating mechanism 30 can be achieved, and the flexibility is improved.

It can be understood that, each of the third transmission member 491 and the fourth transmission member 492 may be composed of a slider 4911 and a connecting head 4912. Alternatively, each of the third transmission member 491 and the fourth transmission member 492 may be composed of a slider 4911, a connecting head 4912, and a connecting arm 4913. Alternatively, one of the third transmission member 491 and the fourth transmission member 492 is composed of a slider 4911 and a connecting head 4912, and another of the third transmission member 491 and the fourth transmission member 492 is composed of a slider 4911, a connecting head 4912, and a connecting arm 4913, which are not limited.

Optionally, referring to FIG. 4, the linear motor may further include a bottom plate 485. Each of the stator 481 and the guide member 483 is mounted on the bottom plate 485, and an extending direction of the stator 481, an extending direction of the guide member 483, and an extending direction of the bottom plate 485 are the same. Optionally, the linear motor may further include an end plate 486. One end plate 486 is disposed at each of two opposite ends of the bottom plate 485. The stator 481 and the guide member 483 may also be connected to the end plate 486. The end plate 486 can play a role in support and fixing, and play a role in a limitation to a maximum stroke of motion of the mover 482. Optionally, the linear motor may further include a cover plate 487. Two ends of the cover plate 487 are connected and fixed to the end plate 486, respectively. The cover plate 487 is disposed right above the stator 481 and spaced apart from the stator 481, so as to play a protective role. The mover 482 may be disposed at one side of the cover plate 487 facing towards the stator 481. The slider 4911 may be disposed at one side of the cover plate 487 facing away from the stator 481. The mover 482 and the slider 4911 both exceed two edges of the cover plate 487 in the width direction of the cover plate 487, and are connected at the two edges of the cover plate 487 where the mover 482 and the slider 4911 both exceed. The cover plate 487 may also function to guide the mover 482 and the slider 4911.

In an embodiment, referring to FIG. 1 to FIG. 3, the robotic arm 100 further includes a base 80 and a moving mechanism 90. The first support mechanism 10 and the second support mechanism 20 are both disposed on the base 80. The base 80 is disposed on the moving mechanism 90. The moving mechanism 90 is configured to drive the base 80 to move.

The base 80 may be in a plate shape or in any other feasible shapes. The first driving member 44 and the second driving member 46 of each of the first support mechanism 10 and the second support mechanism 20 may be disposed on the base 80. When each of the first transmission member 45 and the second transmission member 47 is a lead screw and nut pair, at least part of the first transmission member 45 and at least part of the second transmission member 47 may also be disposed on the base 80, which is not limited herein.

The moving mechanism 90 can be any feasible mechanism, and can drive the base 80 to move in at least one degree of freedom. For example, as illustrated in FIG. 1 to FIG. 3, the moving mechanism 90 can drive the base 80 to move linearly in a horizontal direction. Optionally, the moving mechanism 90 includes a driving assembly and a transmission assembly. The transmission assembly is connected to the driving assembly and the base 80. The driving assembly may be a motor, an air cylinder, or the like, and the transmission assembly may be a lead screw and nut pair, a gear pair, a belt and pulley pair, or the like, which are not limited herein.

By providing the base 80 and the moving mechanism 90, the first support mechanism 10 and the second support mechanism 20 can be driven to move as a whole, and the degree of freedom of motion of the robotic arm 100 can be increased, thereby facilitating a change in the spatial position of the operating mechanism 30 and facilitating experimental operations.

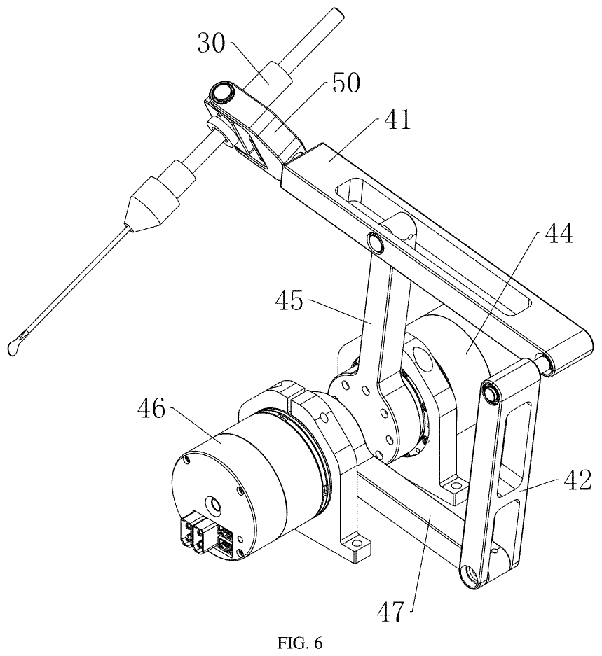

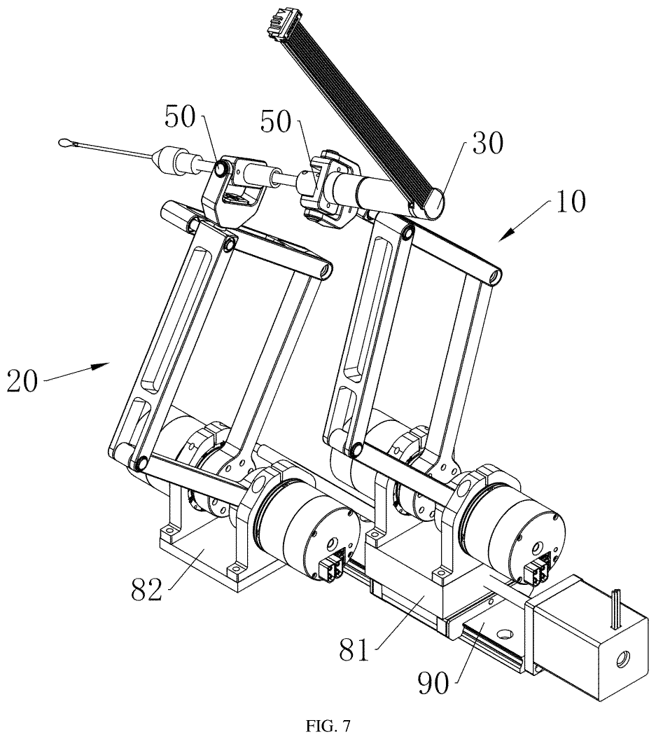

Referring to FIG. 7, in another embodiment, the robotic arm 100 further includes a first base 81, a second base 82, and a moving mechanism 90. The first support mechanism 10 is disposed on the first base 81. The second support mechanism 20 is disposed on the second base 82. The first base 81 or the second base 82 is disposed on the moving mechanism 90. The moving mechanism 90 is configured to drive the first base 81 or the second base 82 disposed on the moving mechanism 90 to move.

Compared with the previous embodiment, in this embodiment, one of the first base 81 and the second base 82 can be moved by the moving mechanism 90, another of the first base 81 and the second base 82 can remain stationary. Therefore, one of the first support mechanism 10 and the second support mechanism 20 can move relative to another of the first support mechanism 10 and the second support mechanism 20, thereby further improving the flexibility of the operating mechanism 30 disposed on the first support mechanism 10 and the second support mechanism 20, and increasing the adaptability of the operating mechanism 30.

Preferably, the moving mechanism 90 is connected to the first base 81 and is configured to drive the first base 81 to move, and the second base 82 may remain fixed. With this arrangement, the stroke of the operating mechanism 30 in the moving direction of the first base 81 can be increased, and the operating range of the operating mechanism 30 can be expanded.

Referring to FIG. 1 to FIG. 8, a powder scooping apparatus 1000 is further provided in an embodiment of the present disclosure. The powder scooping apparatus 1000 includes an operating mechanism 30 and the robotic arm 100 according to any one of the above embodiments. The operating mechanism 30 is connected to each of the first support mechanism 10 and the second support mechanism 20 of the robotic arm 100. The operating mechanism 30 is configured to scoop powder.

The specific structure of the operating mechanism 30 is not limited, and the specific manner of scooping powder is also not limited. According to the contents of the foregoing embodiments, the operating mechanism 30 is connected to each of the first support mechanism 10 and the second support mechanism 20. Specifically, the first support mechanism 10 and the second support mechanism 20 are connected to the operating mechanism 30 at different positions of the operating mechanism 30. The motion of at least one of the first support mechanism 10 or the second support mechanism 20 is sufficient to drive the operating mechanism 30 to move.

Compared with a general-purpose robotic arm, the robotic arm 100 in the embodiments of the present disclosure can be freely adjusted according to the required operation and have high adaptability. Therefore, the powder scooping apparatus 1000 in the embodiments of the present disclosure can also be freely adjusted and have high adaptability.

In an embodiment, the operating mechanism 30 may consist of a powder scooping rod 33 having a scoop 331. Powder scooping and powder pouring of the powder scooping rod 33 are implemented by the cooperation of the first support mechanism 10 and the second support mechanism 20 of the robotic arm 100.

In an embodiment, referring to FIG. 1 to FIG. 3, the operating mechanism 30 includes a first powder-scooping driving member 31 and a powder scooping member (not shown). The first powder-scooping driving member 31 is connected to one end of the powder scooping member and is configured to drive the powder scooping member to move (i.e., to translate and/or rotate). The first support mechanism 10 is connected to the first powder-scooping driving member 31. The second support mechanism 20 is connected to the powder scooping member. The powder scooping member is provided with a scoop 331 at another end of the powder scooping member away from the first powder-scooping driving member 31.

The first powder-scooping driving member 31 may be a rotary motor, or may be other driving structures, which are not limited. The powder scooping member is substantially in the shape of a rod extending linearly as a whole, and a length direction of the powder scooping member is a direction extending linearly. One end of the powder scooping member in the length direction of the powder scooping member is connected to the first powder-scooping driving member 31, and the powder scooping member is provided with the scoop 331 at an end portion of another end of the powder scooping member. The scoop 331 is in a scoop shape. The scoop 331 is configured to scoop powder out (powder scooping) and pouring powder out (powder pouring).

When the powder scooping apparatus 1000 operates, on the one hand, the operating mechanism 30 can be driven by the motion of the robotic arm 100 to move, so as to reach a designated position; on the other hand, the first powder-scooping driving member 31 drives the powder scooping member to scoop powder or pour powder, so that the scoop 331 can move in the space and perform a powder scooping operation or a powder pouring operation.

By providing the first powder-scooping driving member 31 to drive the motion of the powder scooping member, the scoop 331 of the powder scooping member realizes an operation of powder scooping or powder pouring, and the structure is simple and easy to implement.

Optionally, referring to FIG. 1 to FIG. 3, the powder scooping member includes a sliding sleeve 32 and a powder scooping rod 33. The sliding sleeve 32 includes a bushing 321 and a guide shaft 322. The bushing 321 is sleeved on the guide shaft 322. The guide shaft 322 is rotatable relative to the bushing 321. One end of the guide shaft 322 is connected to the first powder-scooping driving member 31, and another end of the guide shaft 322 is connected to one end of the powder scooping rod 33. The first powder-scooping driving member 31 is configured to drive the guide shaft 322 to rotate to drive the powder scooping rod 33 to rotate. The powder scooping rod 33 is provided with the scoop 331 at another end of the powder scooping rod 33 away from the guide shaft 322. The second support mechanism 20 is connected to the bushing 321.

The sliding sleeve 32 may be a standard component or a general-purpose component. The bushing 321 is substantially in the shape of a sleeve, and an outer circumferential surface of the bushing 321 may be cylindrical or cylindrical with an annular protrusion, which is not limited herein. The guide shaft 322 is a cylindrical straight rod. Two ends of the guide shaft 322 may extend out of the bushing 321, or one end of the guide shaft 322 extends out of the bushing 321 and another end of the guide shaft 322 does not extend out of the bushing 321, which is not limited herein. The bushing 321 is connected and fixed to the second support mechanism 20, and the guide shaft 322 can rotate relative to the bushing 321, so that the first powder-scooping driving member 31 drives the guide shaft 322 to rotate, to drive the powder scooping rod 33 to rotate, to further drive the scoop 331 to rotate, thereby realizing an operation of powder scooping or powder pouring.

The powder scooping member includes the sliding sleeve 32 and the powder scooping rod 33, which has a simple structure and facilitates the connection with the robotic arm 100.

Optionally, referring to FIG. 1 to FIG. 3, the guide shaft 322 is also movable relative to the bushing 321. The first support mechanism 10 and the second support mechanism 20 are movable close to each other or away from each other. A direction in which the guide shaft 322 moves relative to the bushing 321 is an axial direction of the guide shaft 322. In this way, the first support mechanism 10 and the second support mechanism 20 are movable close to or away from each other by means of the motion of the guide shaft 322 relative to the bushing 321, thereby further improving the flexibility of the powder scooping apparatus 1000, facilitating free adjustment and increasing adaptability.

Optionally, referring to FIG. 1 to FIG. 3, the powder scooping member further includes an adapter 34. One end of the adapter 34 is detachably connected to the guide shaft 322, and another end of the adapter 34 is detachably connected to the powder scooping rod 33.

The specific structure of the adapter 34 is not limited. The detachable connection between the adapter 34 and each of the guide shaft 322 and the powder scooping rod 33 may be threaded connection, snap-fit connection, interference fit, or the like, which is not limited herein. By providing the adapter 34, the connection between the powder scooping rod 33 and the guide shaft 322 can be conveniently established, and the powder scooping rod 33 can be easily replaced to switch between scoops 331 of different specifications.

In a specific embodiment, referring to FIG. 1 to FIG. 3, each of the first support mechanism 10 and the second support mechanism 20 includes a support structure 40 and a joint 50. The joint 50 includes a first rotating member 51 and a second rotating member 52. The first rotating member 51 is rotatably connected to the support structure 40. The second rotating member 52 is rotatably connected to the first rotating member 51. The second rotating member 52 of the first support mechanism 10 is connected to the first powder-scooping driving member 31. The second rotating member 52 of the second support mechanism 20 is connected to the powder scooping member.

The first powder-scooping driving member 31 is a rotary motor. The second rotating member 52 of the first support mechanism 10 is fixedly connected to a casing of the rotary motor of the first powder-scooping driving member 31. An output shaft of the rotary motor of the first powder-scooping driving member 31 is connected to the guide shaft 322. The second rotating member 52 of the second support mechanism 20 is fixedly connected to the bushing 321. In this way, the first powder-scooping driving member 31 can drive the guide shaft 322 to rotate through the output shaft of the rotary motor, to drive the powder scooping rod 33 to rotate, thereby realizing operation of powder scooping and powder pouring, and the structure is simple and easy to implement.

Optionally, the output shaft of the rotary motor of the first powder-scooping driving member 31 may be connected to the guide shaft 322 through a connector 35. The connector 35 may be a coupling or any other feasible structure, which is not limited herein. The connector 35 may be connected to each of the output shaft of the rotary motor and the guide shaft 322 by means of detachable connection, such as threaded connection, snap-fit connection, or the like, which is not limited herein. By providing the connector 35, the connection between the first powder-scooping driving member 31 and the guide shaft 322 can be conveniently established.

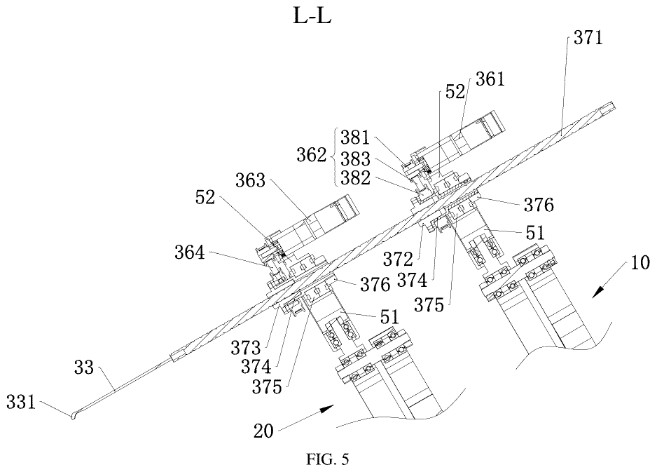

In yet another embodiment, with reference to FIG. 4 and FIG. 5, the operating mechanism 30 includes a second powder-scooping driving member 361, a first powder-scooping transmission member 362, a third powder-scooping driving member 363, a second powder-scooping transmission member 364, and a powder scooping member. The first powder-scooping transmission member 362 and the second powder-scooping transmission member 364 are both connected to the powder scooping member. The first support mechanism 10 is connected to the second powder-scooping driving member 361. The second powder-scooping driving member 361 is connected to the first powder-scooping transmission member 362. The second support mechanism 20 is connected to the third powder-scooping driving member 363. The third powder-scooping driving member 363 is connected to the second powder-scooping transmission member 364. The first support mechanism 10 and the second support mechanism 20 are both movably connected to the powder scooping member (for example, the first support mechanism 10 and the second support mechanism 20 are both slidably connected to the powder scooping member, and/or the first support mechanism 10 and the second support mechanism 20 are both rotatably connected to the powder scooping member). One end of the powder scooping member away from the second powder-scooping driving member 361 is provided with a scoop. The second powder-scooping driving member 361 and the third powder-scooping driving member 363 are configured to drive the powder scooping member, through a corresponding powder-scooping transmission member, to perform any one of a translational motion, a rotational motion, or a composite motion of the translational motion and the rotational motion.

Optionally, each of the first support mechanism 10 and the second support mechanism 20 includes the support structure 40 and the joint 50. The joint 50 of each of the first support mechanism 10 and the second support mechanism 20 includes the first rotating member 51 and the second rotating member 52 described above. The first rotating member 51 is connected to the corresponding support structure 40. The second rotating member 52 is rotatably connected to the corresponding first rotating member 51. The second rotating member 52 of the first support mechanism 10 is connected and fixed to the second powder-scooping driving member 361. The second rotating member 52 of the first support mechanism 10 is further movably connected to the powder scooping member. The second rotating member 52 of the second support mechanism 20 is connected and fixed to the third powder-scooping driving member 363. The second rotating member 52 of the second support mechanism 20 is further movably connected to the powder scooping member. Each of the second powder-scooping driving member 361 and the third powder-scooping driving member 363 may be a rotary motor, a linear motor, or a hydraulic pump, which is not limited herein.

The structures of the first powder-scooping driving member 362, the second powder-scooping driving member 364, and the powder scooping member may be not limited, as long as the powder scooping member can be driven by the second powder-scooping driving member 361 and the third powder-scooping driving member 363 to perform any one of the translational motion, the rotational motion, or the composite motion of the translational motion and the rotational motion.

When the powder scooping member moves, the powder scooping member moves in its own axial direction, so that the operation of moving the powder scooping member forward or backward can be realized. When the powder scooping member rotates, the powder scooping member rotates around its own axis, so that the operation of powder scooping and powder pouring can be realized. When the powder scooping member performs the composite motion of the translational motion and the rotational motion, a composite motion of any combination of forward motion, backward motion, powder scooping, and powder pouring can be realized. In this way, the flexibility of the operating mechanism 30 itself can be significantly improved.

In an embodiment, with reference to FIG. 4 and FIG. 5, the powder scooping member includes a screw shaft 371, a first nut 372, a second nut 373, and a powder scooping rod 33. The first support mechanism 10 is rotatably connected to the first nut 372. The first powder-scooping transmission member 362 is connected to the first nut 372. The second support mechanism 20 is rotatably connected to the second nut 373. The second powder-scooping transmission member 364 is connected to the second nut 373. The screw shaft 371 passes through the first nut 372 and the second nut 373. The first nut 372 and the second nut 373 both are movably connected to the screw shaft 371. One end of the screw shaft 371 away from the second powder-scooping driving member 361 is connected to one end of the powder scooping rod 33. One end of the powder scooping rod 33 away from the screw shaft 371 is provided with the scoop 331.

One of the first nut 372 and the second nut 373 is a screw nut, and another of the first nut 372 and the second nut 373 is a spline nut. The screw shaft 371 defines a helical groove 3711 spirally extending in an axial direction of the screw shaft 371 and a straight groove 3712 linearly extending in the axial direction of the screw shaft 371. The screw nut is engaged with the helical groove 3711. The spline nut is engaged with the straight groove 3712. At least one of the first nut 372 or the second nut 373 is rotatable relative to the screw shaft 371 to drive the screw shaft 371 to perform any one of the translational motion, the rotational motion, or the composite motion of the translational motion and the rotational motion.

In this embodiment, the screw shaft 371 may be connected to the powder scooping rod 33 by means of welding, adhesive connection, snap-fit connection, threaded connection, or the like. Optionally, the powder scooping member may also include an adapter 34. One end of the adapter 34 is fixedly connected to or detachably connected to the screw shaft 371, and another end of the adapter 34 is detachably connected to the powder scooping rod 33, so as to facilitate replacement of the powder scooping rod 33. The powder-scooping transmission member may be connected to the nut by means of threaded connection, adhesive connection, snap-fit connection, or the like.

In this embodiment, the first nut 372, the second nut 373, and the screw shaft 371 form a screw and spline pair as a whole. The second powder-scooping driving member 361 can drive the first nut 372 to rotate. The third powder-scooping driving member 363 can drive the second nut 373 to rotate. One of the first nut 372 and the second nut 373 is the screw nut and another of the first nut 372 and the second nut 373 is the spline nut, the screw nut rotates to generate a transmission effect with the helical groove 3711, and the spline nut rotates to generate a transmission effect with the straight groove 3712, so that the screw shaft 371 can perform any one of the translational motion, the rotational motion, or the composite motion of the translational motion and the rotational motion.

When the screw nut is fixed and does not rotate (i.e., a corresponding powder-scooping driving member does not operate) while the spline nut rotates (i.e., a corresponding powder-scooping driving member operates), the screw shaft 371 performs a composite motion of helical forward or helical backward. When the screw nut rotates while the spline nut is fixed and does not rotate, the screw shaft 371 moves linearly. When the screw nut and the spline nut both rotate, the screw shaft 371 substantially rotates in situ.

Exemplarily, as illustrated in FIG. 4 and FIG. 5, the first nut 372 is a screw nut, and the second nut 373 is a spline nut.

Optionally, the powder scooping apparatus 1000 may further be provided with a bearing 375. The bearing 375 is located in the second rotating member 52 of the joint 50. An outer ring of the bearing 375 is connected to an inner wall of the second rotating member 52. An inner ring of the bearing 375 is connected to the first nut 372 or the second nut 373. Therefore, the first nut 372 or the second nut 373 is rotatably connected to a corresponding support mechanism.

Optionally, since the first nut 372 and the second nut 373 are limited in size, and direct connection between each of the first nut 372 and the second nut 373 and the bearing 375 may not be feasible, the powder scooping apparatus 1000 may further be provided with an adapter sleeve 374 and a locking nut 376. The adapter sleeve 374 is at least partially located in the bearing 375 and is connected to the inner ring of the bearing 375. The adapter sleeve 374 is sleeved on the screw shaft 371 and is not in a transmission relationship with the screw shaft 371. There is a gap between the adapter sleeve 374 and the screw shaft 371. The locking nut 376 is connected to and locked with one end of the adapter sleeve 374. Each of the first nut 372 and the second nut 373 can be provided with the adapter sleeve 374, the bearing 375, and the locking nut 376. Each of the first nut 372 and the second nut 373 is connected and fixed to one end of the corresponding adapter sleeve 374 away from the locking nut 376. Since the length of each of the first nut 372 and the second nut 373 is limited, by providing the adapter sleeve 374, each of the first nut 372 and the second nut 373 can be connected to the corresponding bearing 375. By locking the locking nut 376 with one end of the adapter sleeve 374 that exceeds the second rotating member 52 and is away from the first nut 372 or the second nut 373, an axial motion of the first nut 372 and the second nut 373 can be restricted, thereby ensuring structural stability. When the second powder-scooping driving member 361 drives the first nut 372 to rotate and the third powder-scooping driving member 363 drives the second nut 373 to rotate, the first nut 372 drives the adapter sleeve 374 connected to the first nut 372 to rotate and the second nut 373 drives the adapter sleeve 374 connected to the second nut 373 to rotate. Accordingly, the rotation of the adapter sleeve 374 causes the inner ring of the bearing 375 connected to the adapter sleeve 374 to rotate, while the outer ring of the bearing 375 and the second rotating member 52 do not rotate along with rotation of the inner ring of the bearing 375. Therefore, the first nut 372 rotates relative to the first support mechanism 10, and the second nut 373 rotates relative to the second support mechanism 20.

The adapter sleeve 374 may be connected to each of the first nut 372 or the second nut 373 by means of threaded connection, adhesive connection, snap-fit connection, or the like, which is not limited herein. The adapter sleeve 374 may be connected to the bearing 375 by means of interference fit, transition fit, or the like, which is not limited herein.

By providing the screw and spline pair, it is possible for the screw shaft 371 with a simple structure to achieve any motion such as the translational motion, the rotational motion, or the composite motion of the translational motion and the rotational motion, so that the flexibility of the powder scooping member can be improved, so as to achieve a more complex operation.

Optionally, referring to FIG. 4 and FIG. 5, at least one of the first powder-scooping driving member 362 or the second powder-scooping driving member 364 includes a first synchronous pulley 381, a second synchronous pulley 382, and a synchronous belt 383 connected between the first synchronous pulley 381 and the second synchronous pulley 382. The first synchronous pulley 381 is connected to a corresponding powder-scooping driving member. The second synchronous pulley 382 is connected to a corresponding nut.

Exemplarily, as illustrated in FIG. 5, the first synchronous pulley 381 is connected to the second powder-scooping driving member 361 (or the third powder-scooping driving member 363). The second synchronous pulley 382 is sleeved on the corresponding nut or adapter sleeve 374 and is fixed to the corresponding nut or adapter sleeve 374 (by means of threaded connection, adhesive connection, snap-fit connection, or the like). The synchronous belt 383 is wound around the first synchronous pulley 381 and the second synchronous pulley 382. When the corresponding powder-scooping driving member operates, the first synchronous pulley 381 is driven to rotate, to drive the second synchronous pulley 382 by the synchronous belt 383 to rotate, so that the corresponding nut can be driven to rotate, thereby realizing the required motion of the screw shaft 371.

Optionally, at least one of the first powder-scooping driving member 362 or the second powder-scooping driving member 364 includes a first gear and a second gear engaged with each other. The first gear is connected to a corresponding powder-scooping driving member. The second gear is connected to a corresponding nut.

The power from the powder-scooping driving member can likewise be transmitted to the corresponding nut by means of gearing transmission.

In an embodiment, the powder scooping apparatus 1000 further includes a storage container (not shown) and a target container (not shown). The storage container is configured to contain powder. The robotic arm 100 is configured to drive the operating mechanism 30 to move, enabling the operating mechanism 30 to scoop the powder in the storage container out and transfer the powder to the target container.

Each of the storage container and the target container may be a test tube, a reagent bottle, a wild-mouth bottle, or the like, which is not limited herein. The storage container and the target container may be placed on a corresponding support frame (not shown), and the operation of powder scooping and powder pouring is realized by the motion of the operating mechanism 30. The storage container and the target container may also be driven by another mechanism to move. That is, during the motion of the operating mechanism 30, at least one of the storage container or the target container can also move, specifically, the operating mechanism 30 and at least one of the storage container or the target container move towards each other, so as to accelerate the speed of operation of powder scooping and powder pouring.

During the operation of powder scooping, the robotic arm 100 drives the operating mechanism 30 to move, so that the scoop 331 of the operating mechanism 30 extends into the storage container, the powder-scooping driving member drives the powder scooping member to rotate, thereby causing the scoop 331 to rotate and scoop the powder. Then, the robotic arm 100 drives the operating mechanism 30 to withdraw from the storage container and move the scoop 331 above or inside the target container, the powder-scooping driving member drives the powder scooping member to rotate, so that the scoop 331 rotates and pours the powder, thereby completing the operation of transferring powder from the storage container to the target container.

The size and shape of the scoop 331 can be designed according to needs, so that the amount of powder transferred by the scoop 331 once is fixed, and one or more operations can be performed according to needs, thereby finally realizing complete transfer of the required amount of powder.

In each of the foregoing embodiments, a rotational connection manner between components may be hinging connection, pivoting connection, shaft connection, riveting connection, or the like, which is not limited herein. For example, the rotational connection may be implemented by using a structure such as a rotating shaft or a universal joint.

Referring to FIG. 9, an experimental device 2000 is further provided in an embodiment of the present disclosure. The experimental device 2000 includes a robotic arm 100 of any one of the foregoing embodiments. The experimental device 2000 can be configured to perform various experiments, and is not limited to the foregoing powder transfer.

Referring to FIG. 10, an experimental device 2000 is further provided in an embodiment of the present disclosure. The experimental device 2000 includes the powder scooping apparatus 1000 according to any one of the foregoing embodiments. The experimental device 2000 can transfer powder by using the powder scooping apparatus 1000, so as to realize the required experimental operation.

The foregoing experimental device 2000 has the characteristics of free adjustment and strong adaptability.

In the description of embodiments of the present disclosure, it may be noted that orientation or positional relations indicated by terms such as “center”, “on”, “under”, “left”, “right”, “vertical”, “horizontal”, “in”, “out”, and the like are orientation or positional relations based on the accompanying drawings, only for facilitating description of the present disclosure and simplifying the description, rather than explicitly or implicitly indicating the referred apparatuses or elements must be in a particular orientation or constructed or operated in the particular orientation, and therefore they may not be construed as limiting the present disclosure.

The above embodiments are only one of preferable embodiments of the present disclosure, and cannot be used to limit the scope of the claims of the present disclosure. Those of ordinary skill in the art can understand all or a part of the process to realize the above embodiments of the present disclosure, and the equivalent changes made in accordance with the claims of the present disclosure still belong to the scope of the present disclosure.

What is claimed is:

1. A robotic arm, comprising a first support mechanism and a second support mechanism, wherein the first support mechanism and the second support mechanism are both configured to be connected to an operating mechanism, and at least one of the first support mechanism or the second support mechanism is configured to drive the operating mechanism to move;
wherein the at least one of the first support mechanism or the second support mechanism comprises a support structure and a joint, the joint is rotatably connected to one end of the support structure, and the joint is configured to be connected to the operating mechanism.

2. The robotic arm of claim 1, wherein the joint comprises a first rotating member and a second rotating member, the first rotating member is rotatably connected to the support structure, the second rotating member is rotatably connected to the first rotating member, the second rotating member is configured to be connected to the operating mechanism, and a rotation axis of the first rotating member intersects with a rotation axis of the second rotating member.

3. The robotic arm of claim 1, wherein the support structure comprises a first support member and a second support member, the joint is rotatably connected to one end of the first support member, the second support member is rotatably connected to the first support member, and at least one of the first support member or the second support member is configured to move to drive the joint to move.

4. The robotic arm of claim 3, wherein the support structure further comprises a first driving member, a first transmission member, a second driving member, and a second transmission member, the first transmission member is rotatably connected to the first support member, the second transmission member is rotatably connected to the second support member, the first driving member is connected to the first transmission member and is configured to drive the first transmission member to drive the first support member to move, and the second driving member is connected to the second transmission member and is configured to drive the second transmission member to drive the second support member to move.

5. The robotic arm of claim 4, wherein each of the first driving member and the second driving member is a rotary motor, the first transmission member comprises any one or a combination of a connecting rod, a lead screw and nut pair, a gear and rack pair, or a worm wheel and worm pair, and the second transmission member comprises any one or a combination of a connecting rod, a lead screw and nut pair, a gear and rack pair, or a worm wheel and worm pair; and
a rotation axis of the first driving member is parallel to a rotation axis of the second driving member.

6. The robotic arm of claim 5, wherein each of the first transmission member, the first support member, the second transmission member, and the second support member is a connecting rod; and
the first transmission member is rotatably connected to one end of the first support member away from the joint, the second support member is rotatably connected to one end of the first support member close to the joint, and the second transmission member is rotatably connected to one end of the second support member away from the joint; or the first transmission member is rotatably connected to the first support member at a middle of the first support member, one end of the second support member is connected to the second transmission member, and another end of the second support member is rotatably connected to the end of the first support member away from the joint.

7. The robotic arm of claim 5, wherein each of the first transmission member and the second transmission member is a lead screw and nut pair, a lead screw of the first transmission member is connected to the first driving member, and a lead screw of the second transmission member is connected to the second driving member, one end of the first support member away from the joint is rotatably connected to a nut of the first transmission member, and one end of the second support member away from the joint is rotatably connected to a nut of the second transmission member; and
the lead screw of the first transmission member and the lead screw of the second transmission member are arranged in parallel; and each of the first support member and the second support member is a connecting rod, and a length of the first support member is equal to a length of the second support member.

8. The robotic arm of claim 3, wherein the support structure further comprises a third driving member, a third transmission member, and a fourth transmission member, the third transmission member is rotatably connected to the first support member, the fourth transmission member is rotatably connected to the second support member, the third driving member is connected to each of the third transmission member and the fourth transmission member, and the third driving member is configured to drive the third transmission member and the fourth transmission member to move independently.

9. The robotic arm of claim 8, wherein the third driving member is a linear motor, the linear motor comprises a plurality of independently movable movers, and the third transmission member and the fourth transmission member are connected to different movers of the plurality of movers;
each of the third transmission member and the fourth transmission member comprises a slider, the slider is connected to a corresponding mover at one side of the slider facing towards the mover, and the slider is rotatably connected to a corresponding support member at one side of the slider facing away from the mover;
at least one of the third transmission member or the fourth transmission member further comprises a connecting arm, one end of the connecting arm is connected to a corresponding slider, and another end of the connecting arm is rotatably connected to a corresponding support member; and
each of the first support member and the second support member is a connecting rod.

10. The robotic arm of claim 1, wherein the robotic arm further comprises a base and a moving mechanism, the first support mechanism and the second support mechanism are both disposed on the base, the base is disposed on the moving mechanism, and the moving mechanism is configured to drive the base to move; or
the robotic arm further comprises a first base, a second base, and the moving mechanism, the first support mechanism is disposed on the first base, the second support mechanism is disposed on the second base, the first base or the second base is disposed on the moving mechanism, and the moving mechanism is configured to drive the first base or the second base on the moving mechanism to move.

11. A powder scooping apparatus, comprising an operating mechanism and a robotic arm, wherein the robotic arm comprises a first support mechanism and a second support mechanism, the operating mechanism is connected to each of the first support mechanism and the second support mechanism of the robotic arm, the operating mechanism is configured to scoop powder, at least one of the first support mechanism or the second support mechanism is configured to drive the operating mechanism to move, the at least one of the first support mechanism or the second support mechanism comprises a support structure and a joint, the joint is rotatably connected to one end of the support structure, and the joint is connected to the operating mechanism.

12. The powder scooping apparatus of claim 11, wherein the operating mechanism comprises a first powder-scooping driving member and a powder scooping member, the first powder-scooping driving member is connected to one end of the powder scooping member and is configured to drive the powder scooping member to move, the first support mechanism is connected to the first powder-scooping driving member, the second support mechanism is connected to the powder scooping member, and the powder scooping member is provided with a scoop at another end of the powder scooping member away from the first powder-scooping driving member.

13. The powder scooping apparatus of claim 12, wherein the powder scooping member comprises a sliding sleeve and a powder scooping rod, the sliding sleeve comprises a bushing and a guide shaft, the bushing is sleeved on the guide shaft, the guide shaft is rotatable relative to the bushing, one end of the guide shaft is connected to the first powder-scooping driving member, and another end of the guide shaft is connected to one end of the powder scooping rod, the first powder-scooping driving member is configured to drive the guide shaft to rotate to drive the powder scooping rod to rotate, the powder scooping rod is provided with the scoop at another end of the powder scooping rod away from the guide shaft, and the second support mechanism is connected to the bushing.

14. The powder scooping apparatus of claim 13, wherein the guide shaft is movable relative to the bushing, and the first support mechanism and the second support mechanism are movable close to each other or away from each other; and/or
the powder scooping member further comprises an adapter, one end of the adapter is detachably connected to the guide shaft, and another end of the adapter is detachably connected to the powder scooping rod.

15. The powder scooping apparatus of claim 12, wherein each of the first support mechanism and the second support mechanism comprises the support structure and the joint, the joint comprises a first rotating member and a second rotating member, the first rotating member is rotatably connected to the support structure, and the second rotating member is rotatably connected to the first rotating member; and the second rotating member of the first support mechanism is connected to the first powder-scooping driving member, and the second rotating member of the second support mechanism is connected to the powder scooping member.

16. The powder scooping apparatus of claim 11, wherein the operating mechanism comprises a second powder-scooping driving member, a first powder-scooping transmission member, a third powder-scooping driving member, a second powder-scooping transmission member, and a powder scooping member, the first powder-scooping transmission member and the second powder-scooping transmission member are both connected to the powder scooping member, the first support mechanism is connected to the second powder-scooping driving member, the second powder-scooping driving member is connected to the first powder-scooping transmission member, the second support mechanism is connected to the third powder-scooping driving member, and the third powder-scooping driving member is connected to the second powder-scooping transmission member; and the first support mechanism and the second support mechanism are both movably connected to the powder scooping member, the powder scooping member is provided with a scoop at one end of the powder scooping member away from the second powder-scooping driving member, and the second powder-scooping driving member and the third powder-scooping driving member are configured to drive the powder scooping member, through a corresponding powder-scooping transmission member, to perform any one of a translational motion, a rotational motion, or a composite motion of the translational motion and the rotational motion.

17. The powder scooping apparatus of claim 16, wherein the powder scooping member comprises a screw shaft, a first nut, a second nut, and a powder scooping rod, the first support mechanism is rotatably connected to the first nut, the first powder-scooping transmission member is connected to the first nut, the second support mechanism is rotatably connected to the second nut, the second powder-scooping transmission member is connected to the second nut, the screw shaft passes through the first nut and the second nut, the first nut and the second nut both are movably connected to the screw shaft, one end of the screw shaft away from the second powder-scooping driving member is connected to one end of the powder scooping rod, and the powder scooping rod is provided with the scoop at another end of the powder scooping rod away from the screw shaft; and
one of the first nut and the second nut is a screw nut, and another of the first nut and the second nut is a spline nut, the screw shaft defines a helical groove spirally extending in an axial direction of the screw shaft and a straight groove linearly extending in the axial direction of the screw shaft, the screw nut is engaged with the helical groove, the spline nut is engaged with the straight groove, and at least one of the first nut or the second nut is rotatable relative to the screw shaft to drive the screw shaft to perform any one of the translational motion, the rotational motion, or the composite motion of the translational motion and the rotational motion.

18. The powder scooping apparatus of claim 17, wherein at least one of the first powder-scooping transmission member or the second powder-scooping transmission member comprises a first synchronous pulley, a second synchronous pulley, and a synchronous belt connected between the first synchronous pulley and the second synchronous pulley, the first synchronous pulley is connected to a corresponding powder-scooping driving member, and the second synchronous pulley is connected to a corresponding nut.

19. The powder scooping apparatus of claim 16, wherein each of the first support mechanism and the second support mechanism comprises the support structure and the joint, the joint comprises a first rotating member and a second rotating member, the first rotating member is rotatably connected to the support structure, and the second rotating member is rotatably connected to the first rotating member; and the second rotating member of the first support mechanism is connected to the second powder-scooping driving member, the second rotating member of the first support mechanism is further movably connected to the powder scooping member, the second rotating member of the second support mechanism is connected to the third powder-scooping driving member, and the second rotating member of the second support mechanism is further movably connected to the powder scooping member.

20. An experimental device, comprising a powder scooping apparatus, wherein the powder scooping apparatus comprises an operating mechanism and a robotic arm, the robotic arm comprises a first support mechanism and a second support mechanism, the operating mechanism is connected to each of the first support mechanism and the second support mechanism of the robotic arm, the operating mechanism is configured to scoop powder, at least one of the first support mechanism or the second support mechanism is configured to drive the operating mechanism to move, at least one of the first support mechanism or the second support mechanism comprises a support structure and a joint, the joint is rotatably connected to one end of the support structure, and the joint is connected to the operating mechanism.
